(19) United States
(12) Patent Application Publication
(10) Pub. No.: US 2026/0118858 A1
(43) Pub. Date: Apr. 30, 2026

(54) SAMPLE MANUFACTURING EVALUATION SYSTEM, CONTROL METHOD FOR SAMPLE MANUFACTURING EVALUATION SYSTEM, AND RECORDING MEDIUM

(71) Applicant: CANON KABUSHIKI KAISHA, Tokyo (JP)

(72) Inventors: MASAYUKI ONO, Kanagawa (JP); MIKA SHIKI, Tokyo (JP)

(21) Appl. No.: 19/363,238

(22) Filed: Oct. 20, 2025

(30) Foreign Application Priority Data
Oct. 24, 2024 (JP) 2024-187791
Sep. 24, 2025 (JP) 2025-158188

(51) Int. Cl. G05B 19/418

(52) U.S. Cl. CPC G05B 19/41875; G05B 2219/32366

(57) ABSTRACT

A sample manufacturing evaluation system includes a sample manufacturing apparatus configured to manufacture a sample on a basis of a manufacturing condition, a measurement apparatus configured to measure the sample, and an information processing apparatus configured to evaluate the sample on a basis of a measurement result of the measurement apparatus and obtain an evaluation result of the sample. In a case where the evaluation result does not satisfy a predetermined condition, the information processing apparatus issues a notification that the evaluation result needs to be corrected.

### BACKGROUND

### Field of the Technology

The present disclosure relates to a technique for manufacturing a sample and evaluating the manufactured sample.

### Description of the Related Art

In development of a material or the like, a sample is manufactured by selecting a raw material, determining a mixture amount of the raw material, and performing processing such as stirring the material or heating the material. In addition, in the development, the manufactured sample is measured, and the measurement result is evaluated. A manufacturing condition of the sample is updated so that this evaluation satisfies a target condition. In such development, data-driven development focusing on improvement of the performance of the material and improvement of the development efficiency is known. In the data-driven development, for example, a manufacturing condition in which a desired characteristic value can be obtained is obtained from the manufacturing condition of the sample and data of the measured characteristic value.

Specifically, the manufacturing condition of the sample is determined, the sample is manufactured in the manufacturing condition, a characteristic value is obtained by measuring the manufactured sample, data analysis is performed by using manufacturing conditions and measurement results of samples obtained thus far, and the manufacturing condition of the next sample is determined. These series of operations are referred to as a search cycle, and the manufacturing condition in which a desired characteristic value can be obtained is obtained by repeatedly performing the search cycle.

Data analysis techniques such as Bayesian optimization are often used for determining the manufacturing condition of the sample, and manufacture and measurement of the sample are often performed manually.

Japanese Patent Application Laid-Open No. 2021-43959 discloses automating the series of operations of the search cycle by automatically performing manufacture and measurement of the sample by using a robot or the like.

In such a system, it is desired to obtain, in a short period of time, a manufacturing condition in which a sample of a good quality can be manufactured.

### SUMMARY

The present disclosure provides a technique advantageous for obtaining, in a short period of time, a manufacturing condition in which a sample of a good quality can be manufactured.

According to a first aspect of the present disclosure, a sample manufacturing evaluation system includes a sample manufacturing apparatus configured to manufacture a sample on a basis of a manufacturing condition, a measurement apparatus configured to measure the sample, and an information processing apparatus configured to evaluate the sample on a basis of a measurement result of the measurement apparatus and obtain an evaluation result of the sample. In a case where the evaluation result does not satisfy a predetermined condition, the information processing apparatus issues a notification that the evaluation result needs to be corrected.

According to a second aspect of the present disclosure, a sample manufacturing evaluation system includes a sample manufacturing apparatus configured to manufacture a sample on a basis of a manufacturing condition, a first measurement apparatus configured to measure the sample, a second measurement apparatus configured to measure the sample with a higher precision than the first measurement apparatus, and an information processing apparatus configured to evaluate the sample on a basis of a measurement result of the first measurement apparatus and obtain an evaluation result of the sample. In a case where the evaluation result does not satisfy a predetermined condition, the information processing apparatus causes the second measurement apparatus to measure the sample, evaluates the sample on a basis of a measurement result of the second measurement apparatus, and updates the evaluation result of the sample.

According to a third aspect of the present disclosure, a sample manufacturing evaluation system includes a sample manufacturing apparatus configured to manufacture a sample on a basis of a manufacturing condition, a measurement apparatus configured to measure the sample, and an information processing apparatus configured to evaluate the sample on a basis of a measurement result of the measurement apparatus and obtain an evaluation result of the sample. The information processing apparatus is configured to in a case where at least one first evaluation result obtained from at least one first measurement result of the sample manufactured in accordance with the manufacturing condition satisfies a predetermined condition, cause the sample manufacturing apparatus to re-manufacture the sample, obtain at least one second measurement result from the measurement apparatus by causing the measurement apparatus to measure the re-manufactured sample, obtain at least one second evaluation result on a basis of the at least one second measurement result, and update the manufacturing condition on a basis of the at least one second evaluation result.

According to a fourth aspect of the present disclosure, a control method for a sample manufacturing evaluation system including a sample manufacturing apparatus, a measurement apparatus, and an information processing apparatus includes causing the sample manufacturing apparatus to manufacture a sample on a basis of a manufacturing condition, causing the measurement apparatus to measure the sample, causing the information processing apparatus to evaluate the sample on a basis of a measurement result of the measurement apparatus and obtain an evaluation result of the sample, and in a case where the evaluation result does not satisfy a predetermined condition, causing the information processing apparatus to issue a notification that the evaluation result needs to be corrected.

According to a fifth aspect of the present disclosure, a control method for a sample manufacturing evaluation system including a sample manufacturing apparatus, a first measurement apparatus, a second measurement apparatus having a higher measurement precision than the first measurement apparatus, and an information processing apparatus includes causing the sample manufacturing apparatus to manufacture a sample on a basis of a manufacturing condition, causing the first measurement apparatus to measure the sample, causing the information processing apparatus to evaluate the sample on a basis of a measurement result of the first measurement apparatus and obtain an evaluation result of the sample, in a case where the evaluation result does not satisfy a predetermined condition, causing the second measurement apparatus to measure the sample, and causing the information processing apparatus to evaluate the sample on a basis of a measurement result of the second measurement apparatus and update the evaluation result of the sample.

According to a sixth aspect of the present disclosure, a control method for a sample manufacturing evaluation system including a sample manufacturing apparatus, a measurement apparatus, and an information processing apparatus, the control method includes causing the sample manufacturing apparatus to manufacture a sample on a basis of a manufacturing condition, causing the measurement apparatus to measure the sample to obtain a first measurement result, causing the information processing apparatus to obtain a first evaluation result on a basis of the first measurement result, in a case where the first evaluation result satisfies a predetermined condition, causing the sample manufacturing apparatus to re-manufacture a sample, causing the measurement apparatus to measure the re-manufactured sample to obtain a second measurement result, causing the information processing apparatus to obtain a second evaluation result on a basis of the second measurement result, and causing the information processing apparatus to update the manufacturing condition on a basis of the second evaluation result.

Features of the present disclosure will become apparent from the following description of embodiments with reference to the attached drawings. The following description of embodiments is described by way of example.

### BRIEF DESCRIPTION OF THE DRAWINGS

FIG. 1A is a block diagram of a sample manufacturing evaluation system according to a first embodiment.

FIG. 1B is a block diagram of an information processing apparatus according to the first embodiment.

FIG. 2A is an explanatory diagram of an information processing portion according to the first embodiment.

FIG. 2B is an explanatory diagram illustrating an example of training data used for machine learning according to the first embodiment.

FIG. 3 is a flowchart of a sample manufacturing evaluation method for the sample manufacturing evaluation system according to the first embodiment.

FIG. 4A is an explanatory diagram illustrating an example of a user interface image according to the first embodiment.

FIG. 4B is an explanatory diagram of an evaluation result according to the first embodiment.

FIG. 5 is an explanatory diagram of a user interface image according to the first embodiment.

FIG. 6 is a diagram for describing an estimator according to the first embodiment.

FIG. 7 is a diagram for describing the estimator according to the first embodiment.

FIG. 8A is an explanatory diagram illustrating an example of an image displayed on a display apparatus according to the first embodiment.

FIG. 8B is an explanatory diagram illustrating an example of an image displayed on the display apparatus according to the first embodiment.

FIG. 9 is an explanatory diagram illustrating an example of an image displayed on the display apparatus according to the first embodiment.

FIG. 10 is a block diagram of a sample manufacturing evaluation system according to the second embodiment.

FIG. 11A is a schematic perspective view of a sample according to the second embodiment.

FIG. 11B is an explanatory diagram of a shape error according to the second embodiment.

FIG. 12A is a schematic side view of a sample and a measurement apparatus that measures the sample according to the third embodiment.

FIG. 12B is an explanatory diagram illustrating an example of a manufacturing condition for manufacturing the sample according to the third embodiment.

FIG. 13A is a graph illustrating an example of a first measurement result of the sample according to the third embodiment.

FIG. 13B is a graph illustrating a difference between an ejection amount of the sample and a target ejection amount according to the third embodiment.

FIG. 13C is a graph illustrating an example of a second measurement result of the sample according to the third embodiment.

FIG. 13D is a graph illustrating a difference between the ejection amount of the sample and the target ejection amount according to the third embodiment.

FIG. 14 is a flowchart of a sample manufacturing evaluation method for a sample manufacturing evaluation system according to the third embodiment.

FIG. 15A is a graph illustrating an example of measurement results of a plurality of samples according to the third embodiment.

FIG. 15B is a graph indicating the difference between a target ejection amount and an average ejection amount of each of the plurality of samples according to the third embodiment.

FIG. 16A is a graph illustrating an example of measurement results of the plurality of samples according to the third embodiment.

FIG. 16B is a graph illustrating the difference between a target ejection amount and an average ejection amount of each of the plurality of samples according to the third embodiment.

### DESCRIPTION OF THE EMBODIMENTS

Embodiments of the present disclosure will be described in detail with reference to drawings. The embodiments shown below are merely examples, and for example, details of the configurations thereof can be appropriately modified for implementation by one skilled in the art within the gist of the present disclosure. To be noted, in the drawings to be referred to in the description of the embodiments below, it is assumed that elements denoted by the same reference numerals have substantially the same functions unless described otherwise.

### First Embodiment

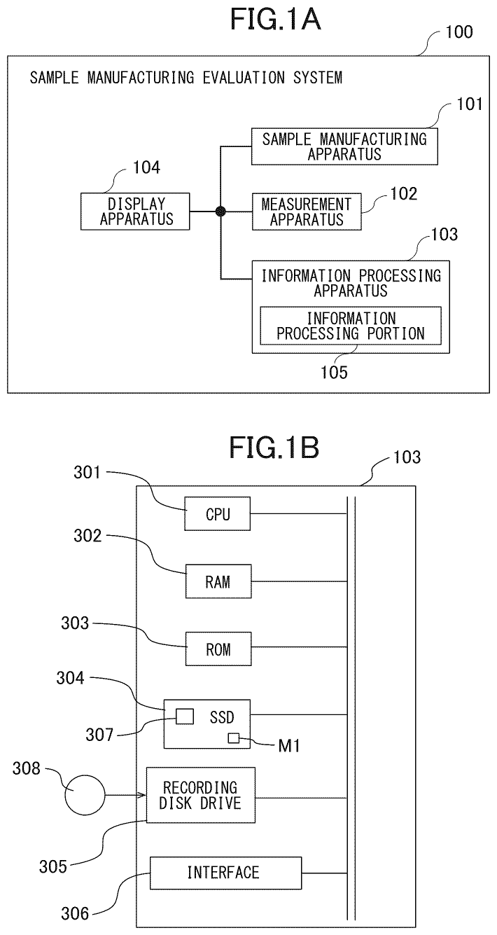

FIG. 1A is a block diagram of a sample manufacturing evaluation system 100 according to a first embodiment. The sample manufacturing evaluation system 100 includes a sample manufacturing apparatus 101, a measurement apparatus 102, an information processing apparatus 103, and a display apparatus 104.

In development of a material or the like, the sample manufacturing evaluation system 100 repeatedly performs a search cycle in which the sample manufacturing evaluation system 100 automatically manufactures a sample on the basis of a manufacturing condition, automatically evaluates the sample, and determines the next manufacturing condition from a data set of the manufacturing condition and the evaluation result. The sample manufacturing evaluation system 100 searches for a manufacturing condition in which a desired sample can be obtained, by executing the search cycle a plurality of times.

Here, the manufacturing condition is a condition required for manufacturing the sample, and includes material conditions such as the kind, characteristics, and amount of the material, and processing conditions for stirring, heating, cooling, curing, and/or the like of the material. That is, the manufacturing condition can include information of the material to be used for manufacturing the sample, information of the mixture amount of the material to be used for manufacturing the sample, and information of the processing temperature (for example, curing temperature) in the manufacturing process for the sample. Other conditions required for manufacturing the sample can be also included in the manufacturing condition. To be noted, the manufacturing condition is a command value (target value) commanded from the sample manufacturing apparatus 101.

An evaluation item of the evaluation by an information processing portion 105 is, for example, an item of a sensory test such as the external appearance of the sample. The number of evaluation items may be one or more. In the case where there are a plurality of evaluation items, the plurality of evaluation items may be optimized simultaneously. The information processing apparatus 103 determines the next manufacturing condition by analyzing a data set in which manufacturing conditions and evaluation results are associated with each other. To determine the next manufacturing condition, Bayesian optimization can be used, but other optimization methods such as the response surface method, regression analysis, and genetic algorithm may be used.

The sample manufacturing apparatus 101 automatically manufactures a sample in a given manufacturing condition in each of the plurality of search cycles. In addition, the information processing apparatus 103 evaluates the sample manufactured by the sample manufacturing apparatus 101. The information processing apparatus 103 includes one or more computers. In the description below, a case where the information processing apparatus 103 includes one computer, that is, one processor will be described as an example.

FIG. 1B is a block diagram of the information processing apparatus 103 according to the first embodiment. The information processing apparatus 103 includes a central processing unit (CPU) 301 serving as an example of a processor, a random access memory (RAM) 302 that is a transitory storage device, a read-only memory (ROM) 303 and a solid state device (SSD) 304 that are non-transitory storage devices (recording media), a recording disk drive 305, and an interface 306 such as an I/O. The non-transitory storage devices are examples of computer-readable recording media, and store a program 307 for causing the CPU 301 to perform an information processing method for control processing for controlling each component of the apparatus, arithmetic processing, and the like. The recording disk drive 305 can load data recorded in a recording disk 308 serving as an example of a recording medium.

To be noted, although in the first embodiment, the non-transitory computer-readable recording medium is, for example, the SSD 304, and the SSD 304 stores the program 307, the configuration is not limited to this. The program 307 may be stored in any recording medium as long as the recording medium is a non-transitory computer-readable recording medium. As the recording medium for supplying the program 307 to a computer, for example, a flexible disk, a hard disk, an optical disk, a magneto-photo disk, a magnetic tape, a nonvolatile memory, or the like can be used. In addition, the program 307 may be obtained from an unillustrated network.

In addition, instead of the configuration described above, the information processing apparatus 103 including a processor may be constituted by, for example, a programmable logic device (PLD) such as a field programmable gate array (FPGA), an application specific integrated circuit (ASIC), a general-purpose or dedicated computer incorporating a program, or a combination of some or all of these.

The CPU 301 of the information processing apparatus 103 executes the program 307, and thus functions as the information processing portion 105 of FIG. 1A. The information processing portion 105 performs learning processing of performing machine learning, evaluation processing of performing inference on the basis of a trained machine learning model and obtaining an evaluation result of the sample as an inference result, and condition determination processing of determining the manufacturing condition to be used for manufacturing the sample from the evaluation result. Then, the information processing portion 105 outputs a control command serving as the manufacturing condition to the sample manufacturing apparatus 101.

The sample manufacturing apparatus 101 manufactures a sample on the basis of the manufacturing condition corresponding to the control command. In the manufacture of the sample, for example, processing such as weighing, dispensation, stirring, defoaming, heating, cooling, compression, decompression, and curing of the material is performed. To be noted, in the sample manufacturing apparatus 101, the manufacture of the sample is performed by, for example, using a robot or an automated machine.

The measurement apparatus 102 is a visual sensor serving as an example of a sensory sensor in the first embodiment. The visual sensor is, for example, a digital camera, and generates, as visual information serving as an example of sensory information, a captured image obtained by imaging the sample manufactured by the sample manufacturing apparatus 101.

The evaluation item of the evaluation by the information processing portion 105 is, for example, a rank related to the amount of scratch included in the image obtained by imaging the sample, and the information processing portion 105 determines the manufacturing condition such that the amount of scratch decreases.

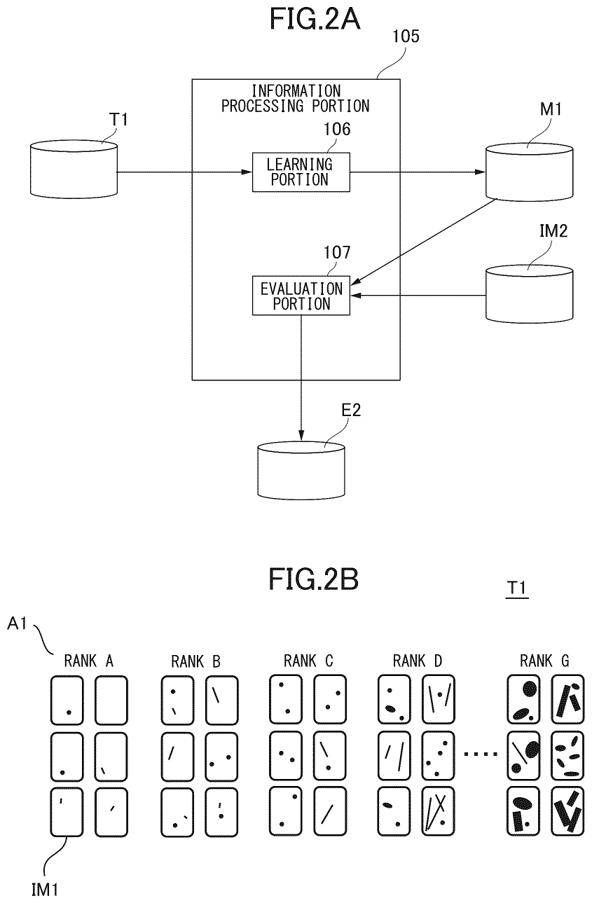

FIG. 2A is an explanatory diagram of the information processing portion 105 according to the first embodiment. The information processing portion 105 includes a learning portion 106 and an evaluation portion 107. The learning portion 106 executes machine learning processing, and the evaluation portion 107 executes evaluation processing and condition determination processing.

The learning portion 106 performs supervised learning as machine learning. The learning portion 106 performs supervised machine learning by using training data T1 including image data and correct answer data, and generates a trained machine learning model M1. The machine learning model M1 is stored in, for example, the SSD 304 of FIG. 1B. As the evaluation processing, the evaluation portion 107 performs inference on an image IM2 serving as input data by using the trained machine learning model M1, and outputs an evaluation result E2 serving as an inference result.

The image IM2 is digital data of a captured image or the like obtained from the measurement apparatus 102. The measurement apparatus 102 generates the image IM2 by imaging the sample manufactured by manufacturing the sample manufacturing apparatus 101.

FIG. 2B is an explanatory diagram illustrating an example of the training data T1 used for machine learning according to the first embodiment. The training data T1 serving as learning data includes a plurality of images IM1 and a plurality of rank values A1 respectively corresponding to the plurality of images IM1. The user (operator) classifies each of the plurality of images IM1 into one of a plurality of ranks from rank A to rank G in accordance with the amount of scratch on the sample captured in each of the plurality of images IM1, and thus generates the training data T1. That is, each of the images IM1 is assigned with a rank value A1 corresponding to one of the ranks from the rank A to the rank G as correct answer data. As described above, the learning data to be learned by the learning portion 106 is generated by the user in accordance with a sensory test conducted by the user. The image IM1 is digital data of a captured image or the like.

Among the plurality of ranks, the rank A is the rank with the highest evaluation in the sensory test, and the rank G is the rank with the lowest evaluation in the sensory test. That is, the rank A, the rank B, the rank C, the rank D, the rank E, the rank F, and the rank G are in this order from the highest to the lowest evaluation in the sensory test. This means that the sample in the image at the rank A is a sample evaluated the best in the sensory test.

The plurality of ranks can be expressed by numerical values. For example, the rank A can be expressed by a rank value A1 of “0”, the rank G can be expressed by a rank value A1 of “1”, and thus the plurality of ranks can be each expressed by a numerical value.

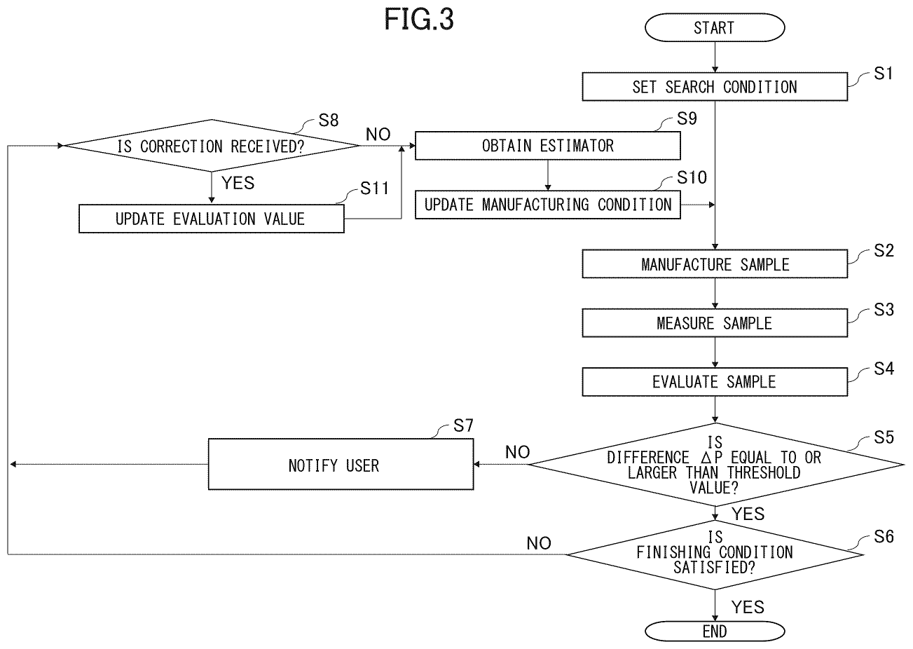

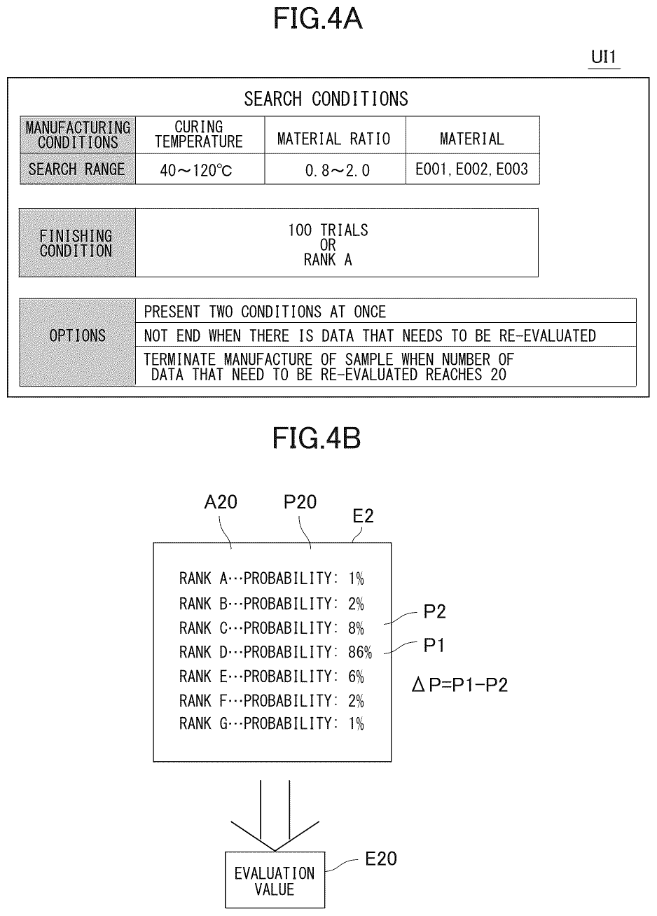

FIG. 3 is a flowchart of a sample manufacturing evaluation method of the sample manufacturing evaluation system 100 according to the first embodiment, that is, a flowchart of a control method for the sample manufacturing evaluation system 100. Step S2 and subsequent steps illustrated in FIG. 3 correspond to a search cycle, and the search cycle is repeated until a finishing condition is satisfied in step S6. Input of data to the information processing apparatus 103 by the user is performed via a graphical user interface (user interface image). FIG. 4A is an explanatory diagram illustrating an example of a user interface image UI1 according to the first embodiment.

First, in step S1, the evaluation portion 107 displays the user interface image UI1 on the display apparatus 104, and receives setting of a search condition from the user via the user interface image UI1. The user may input the search condition in the user interface image UI1 by using an input device such as an unillustrated mouse or an unillustrated keyboard. To be noted, the display apparatus 104 may be a touch panel display including an input device.

The search condition will be described in detail. The search condition may be definition needed for operating the sample manufacturing apparatus 101, and is not limited to what is described below. The search condition includes a search setting related to the manufacturing condition, a search setting related to a finishing condition, and a search setting related to overall operation.

The search setting related to the manufacturing condition defines a search range and the like corresponding to the search item. The search item is an item of the manufacturing condition to be searched for. Examples of the search item include the kind of the material to be used for manufacturing the sample, the ratio of the material, and the curing temperature.

The search range is a range in which the manufacturing condition corresponding to the search item can be changed. For example, in the case where an item that can be expressed by a numerical value such as a material ratio or a curing temperature is set as the search item, one or more values or a continuous numerical range is set as the search range. In the example of FIG. 4A, the range of the curing temperature is set to 40° C. to 120°, and the range of the material ratio is set to 0.8 to 2.0. In this case, as the manufacturing condition, the curing temperature is determined in the range of 40° C. to 120° C., and the material ratio is determined in the range of 0.8 to 2.0.

In addition, for example, the search range may be information not expressed by a numerical value, such as materials E001, E002, and E003. In this case, the manufacturing condition is determined from the materials E001, E002, and E003. As described above, a desired sample is searched for by changing the manufacturing condition in the search range.

The search setting related to the overall operation defines the finishing condition, options, and the like of the search cycle. The finishing condition of the search cycle may be a condition that the search cycle is finished when repeated a designated number of times, or a condition that the search cycle is finished when the evaluated rank reaches a designated rank.

The evaluation portion 107 determines a manufacturing condition on the basis of the search condition, and outputs a control command to the sample manufacturing apparatus 101. To be noted, the initial manufacturing condition may be a lower limit value or upper limit value of the search range, or a random value.

In step S2, the evaluation portion 107 outputs the control command serving as the manufacturing condition to the sample manufacturing apparatus 101, and the sample manufacturing apparatus 101 manufactures the sample on the basis of the manufacturing condition corresponding to the control command.

Next, in step S3, the evaluation portion 107 causes the measurement apparatus 102 to measure the sample. In the present embodiment, since the measurement apparatus 102 is a visual sensor, the visual sensor images the sample, and thus an image IM2 serving as an example of a measurement result (visual information that is sensory information) of the measurement apparatus 102 is obtained from the measurement apparatus 102.

Next, in step S4, the evaluation portion 107 evaluates the sample on the basis of the image IM2 serving as the measurement result of the measurement apparatus 102, and obtains an evaluation result E2 of the sample. In the present embodiment, the evaluation portion 107 obtains the evaluation result E2 corresponding to the image IM2 serving as a measurement result by using the trained machine learning model M1. That is, in the evaluation processing of the information processing portion 105 of the information processing apparatus 103, the sensory test of the sample is not performed by the user but performed automatically by the information processing portion 105 of the information processing apparatus 103 by using the machine learning model M1.

FIG. 4B is an explanatory diagram of an evaluation result E2 according to the first embodiment. The evaluation result E2 includes a plurality of rank values A20. The evaluation portion 107 selects an evaluation value E20 from the plurality of rank values A20. That is, one of the plurality of rank values A20 is the evaluation value E20.

In addition, the evaluation result E2 includes a plurality of probabilities P20 respectively corresponding to the plurality of rank values A20. The evaluation portion 107 sets a rank value corresponding to a first probability P1 that is the highest in the plurality of probabilities P20 as the evaluation value E20. For example, a case where the evaluation result E2 indicates that the probability of the rank A is 1%, the probability of the rank B is 2%, the probability of the rank C is 8%, the probability of the rank D is 86%, the probability of the rank E is 6%, the probability of the rank F is 2%, and the probability of the rank G is 1% is assumed. In this case, the rank D, which is of the highest probability, is set as the evaluation value E20. That is, the probability corresponding to the rank D is the first probability P1 that is the highest probability.

Next, in step S5, the evaluation portion 107 determines whether or not the evaluation result E2 satisfies a predetermined condition. In the present embodiment, the evaluation portion 107 compares the difference ΔP (=P1−P2) between the two highest probabilities P1 and P2 with a preset threshold value. That is, the predetermined condition is a condition that the difference ΔP (=P1−P2) between the first probability P1 and a second probability P2 that is the second highest probability in the plurality of probabilities P20 after the first probability P1 is equal to or larger than the threshold value. The threshold value is, for example, 10%. To be noted, the predetermined condition is not limited to the example described above.

In the case where the evaluation result E2 does not satisfy the predetermined condition, that is, in the case where the difference ΔP is not equal to or larger than the threshold value (difference ΔP is less than the threshold value) (step S5: NO), in step S7, the evaluation portion 107 issues a notification that the evaluation result E2 (specifically, evaluation value E20) needs to be corrected. At this time, the evaluation portion 107 adds, to the evaluation value E20, a label indicating that re-evaluation is needed, and stores the evaluation value E20 in a predetermined region of the SSD 304 or the like in association with the label.

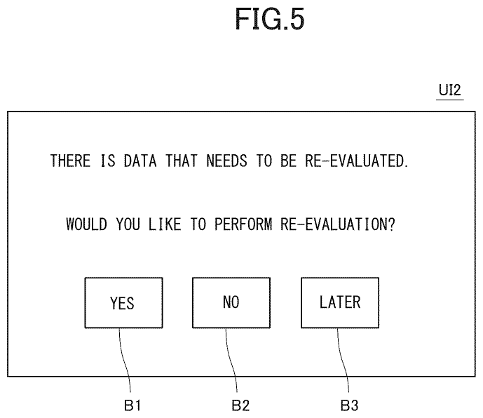

FIG. 5 is an explanatory diagram of a user interface image UI2 according to the first embodiment. In the present embodiment, in step S7, the evaluation portion 107 issues the notification to the user by displaying, on the display apparatus 104, an image indicating that the evaluation result E2 needs to be corrected, for example, the user interface image UI2. To be noted, although a case where the user is notified by using an image has been described, the notification means is not limited to this, and the user may be notified by using an e-mail, a sound, or the like.

In a specific example, in the case where the probability of the rank C is the second probability P2=46% that is the second highest, and the probability of the rank D is the first probability P1=52% that is the highest, the difference ΔP is 52%−46%=6%, which is less than 10%, and therefore the evaluation portion 107 transitions to the processing of step S7. In this case, the evaluation value E20 is output as the value of the rank D of the highest probability.

In step S8, the evaluation portion 107 determines whether or not correction of the evaluation value E20 has been received via the user interface image UI2. In the case where step S8 is YES, that is, in the case where correction of the evaluation value E20 is received, in step S11, the evaluation portion 107 updates the evaluation value E20 to the corrected value, and transitions to the processing of step S9. In addition, in the case where step S8 is NO, that is, in the case where the correction of the evaluation value E20 is not received, the evaluation portion 107 transitions to the processing of step S9 without the update.

Here, the processing of step S7 will be described in detail. In step S7, the evaluation portion 107 displays, for example, the user interface image UI2 on the display apparatus 104 as illustrated in FIG. 5, and notifies the user that the re-evaluation is needed, that is, that the evaluation result E2 (evaluation value E20) needs to be corrected, by the means of a string such as “There is data that needs re-evaluation”.

The user interface image UI2 includes a “Yes” button B1, a “No” button B2, and a “Later”button B3. The buttons B1 to B3 are buttons that the user can operate.

When the “Yes” button B1 is operated, the evaluation portion 107 receives correction of the labeled evaluation value E20 stored in the predetermined region of the SSD 304. When the “No” button B2 is operated, the evaluation portion 107 deletes the label associated with the evaluation value E20, and transitions to the next step S8. When the “Later” button B3 is operated, the evaluation portion 107 just transitions to the next step S8.

As described above, in the first embodiment, the evaluation portion 107 can easily correct the evaluation value E20 by displaying, on the display apparatus 104, the user interface image UI2 for receiving the correction of the evaluation value E20 of the evaluation result E2 from the user.

In step S9, the evaluation portion 107 obtains an estimator by using the evaluation value E20. For example, the estimator is a function including a manufacturing condition parameter (for example, curing temperature) as an independent variable and the evaluation value as a dependent variable. In the case where the correction of the evaluation value E20 is received, the evaluation portion 107 obtains the estimator by using the corrected evaluation value E20.

To generate or update the estimator, Bayesian optimization is preferably used. Bayesian optimization is a method of searching for a minimum value (or maximum value) of a function sequentially and probabilistically, and searches for the minimum value while updating the function each time the data is added.

In step S10, the evaluation portion 107 updates the manufacturing condition by using the estimator, and returns to the processing of step S2. Then, in step S2 of the second or later search cycle of the flowchart illustrated in FIG. 3, the evaluation portion 107 outputs the control command that is a manufacturing condition updated by the sample manufacturing apparatus 101, and the sample manufacturing apparatus 101 manufactures the sample on the basis of the updated manufacturing condition. As described above, in step S2, the sample manufacturing apparatus 101 manufactures the sample on the basis of the updated manufacturing condition each time the manufacturing condition is updated.

In addition, in step S5, in the case where the difference ΔP is equal to or larger than the threshold value, that is, in the case where the result of step S5 is YES, the evaluation portion 107 determines whether or not the finishing condition is satisfied. In the case where the finishing condition is not satisfied, that is, in the case where the result of step S6 is NO, the evaluation portion 107 proceeds to processing of step S8. In the case where the finishing condition is satisfied, that is, in the case where the result of step S6 is YES, the evaluation portion 107 finishes the processing.

As described above, by repeating the search cycle illustrated in FIG. 3 a plurality of times, a plurality of evaluation values E20 are obtained, and the estimator is obtained by using the plurality of evaluation values E20. Then, in the plurality of evaluation values E20, the labeled evaluation value E20 is regarded as a correction target for the user.

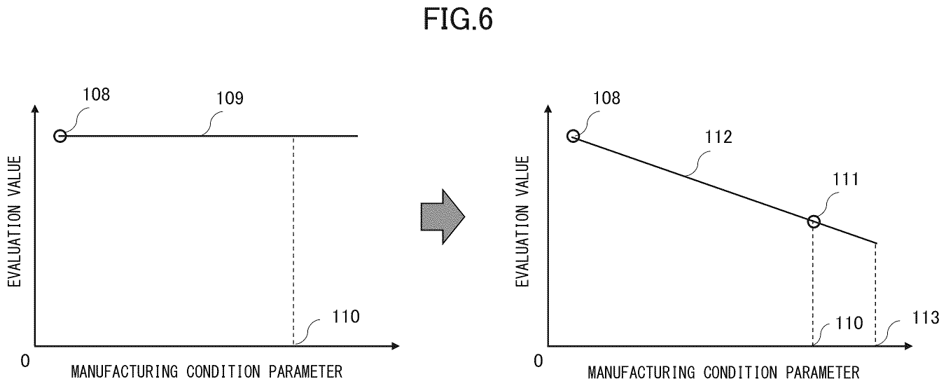

FIG. 6 is a diagram for describing the estimator according to the first embodiment, in the first loop of the search cycle of the flowchart illustrated in FIG. 3, a point 108 is the only data set of the manufacturing condition parameter and the evaluation value as illustrated on the left side in FIG. 6, and an estimator 109 of a constant evaluation value is obtained. Then, a next manufacturing condition parameter 110 is obtained by this estimator 109 in the range of the search condition set in step S1.

In the second loop of the search cycle of the flowchart illustrated in FIG. 3, two points 108 and 111 are data sets of the manufacturing condition parameter and the evaluation value as illustrated on the right side in FIG. 6, and an estimator 112 passing through the two points 108 and 111 is obtained. That is, the estimator 109 is updated to the estimator 112. Then, a next manufacturing condition parameter 113 is obtained by this estimator 112 in the range of the search condition set in step S1.

In the first embodiment, the search cycle, that is, the manufacture of the sample, the measurement of the sample, and the update of the manufacturing condition of the sample are continued even if the evaluation value is not corrected. One of the reasons for this is that in the present embodiment, optimization in which a good manufacturing condition is searched for each time the data sets of the manufacturing condition parameter and the evaluation value are increased, and therefore the number of data sets need to be increased. If the search cycle is stopped until the evaluation value is re-evaluated (that is, corrected) by the user, the data sets do not increase, and the determination of the manufacturing condition of the sample takes time as a result.

The re-evaluation of the evaluation value E20 is performed independently from the flow of the manufacture of the sample, the measurement of the sample, and the update of the manufacturing condition, that is, independently from the flow of the search cycle. For example, in the case where the search cycle is automatically performed at night, there is a case where the user corrects two or more evaluation values labeled to be re-evaluated at once in the morning.

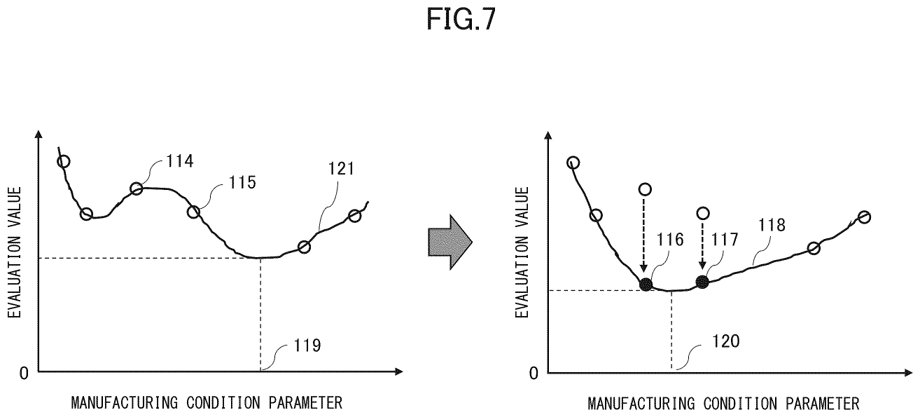

FIG. 7 is a diagram for describing the estimator according to the first embodiment. A case where two evaluation values 114 and 115 among two or more evaluation values labeled to be re-evaluated on the left side of FIG. 7 are corrected will be described as an example. A manufacturing condition parameter 119 for which the evaluation value is the minimum value is obtained from the estimator 121.

It is assumed that the two evaluation values 114 and 115 correspond to, for example, the rank D, and are corrected to evaluation values 116 and 117 corresponding to the rank C, whose probability is close to that of the rank D, by the user. As a result of the labeled evaluation values 114 and 115 being corrected to the evaluation values 116 and 117, the estimator 121 illustrated on the left side in FIG. 7 is updated to an estimator 118 illustrated on the right side in FIG. 7. As a result of this, the minimum value of the evaluation value in the estimator 118 illustrated on the right side in FIG. 7 can be made smaller than the minimum value of the evaluation value in the estimator 121 illustrated on the left side in FIG. 7. Then, a manufacturing condition parameter 120 with which the evaluation value is the minimum value is obtained from the estimator 118 illustrated on the right side in FIG. 7. In this manner, the manufacturing condition parameter 120 with which the result of the sensory test is improved as compared with the case of the manufacturing condition parameter 119 can be obtained.

As described above, as a result of the evaluation values 114 and 115 being replaced by the evaluation values 116 and 117, the next manufacturing condition changes. Therefore, a manufacturing condition matching the finishing condition of the search condition, that is, a manufacturing condition in which a sample of a high quality can be manufactured can be obtained in a short period of time.

The image IM2 corresponding to the corrected evaluation value E20 can be used as training data, and the machine learning model M1 may be updated by causing the learning portion 106 to perform machine learning again by using the image IM2 and the evaluation value E20. As a result of this, the precision of the ranking is improved. Further, all the past evaluation values E20 may be re-evaluated by the evaluation portion 107.

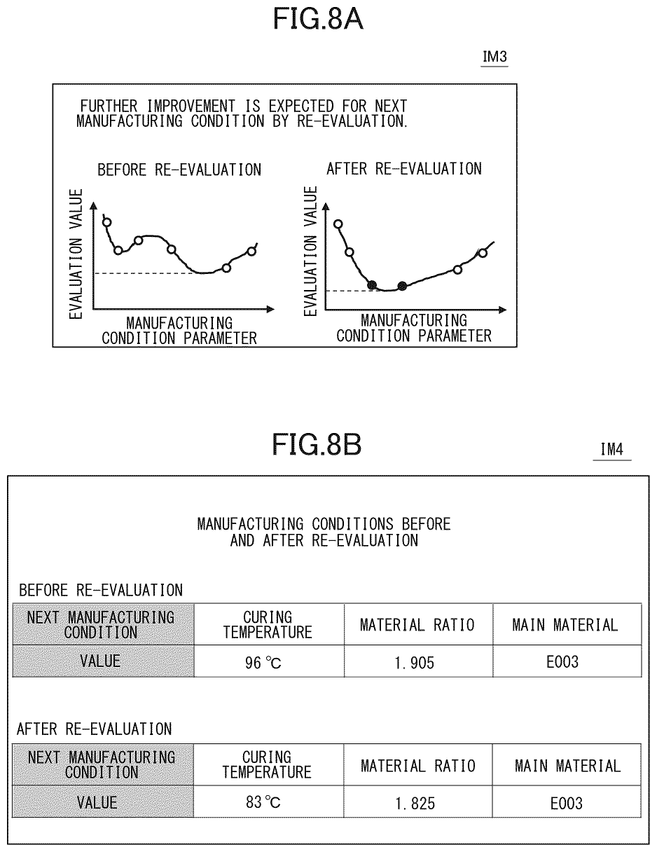

In addition, in the case where the evaluation value is corrected by the user, that is, in the case where the evaluation value is re-evaluated by the user, the evaluation portion 107 may display an image IM3 illustrated in FIG. 8A on the display apparatus 104 and notify the user of the estimators before and after the re-evaluation. In addition, the evaluation portion 107 may display an image IM4 illustrated in FIG. 8B on the display apparatus 104 and notify the manufacturing conditions before and after the re-evaluation.

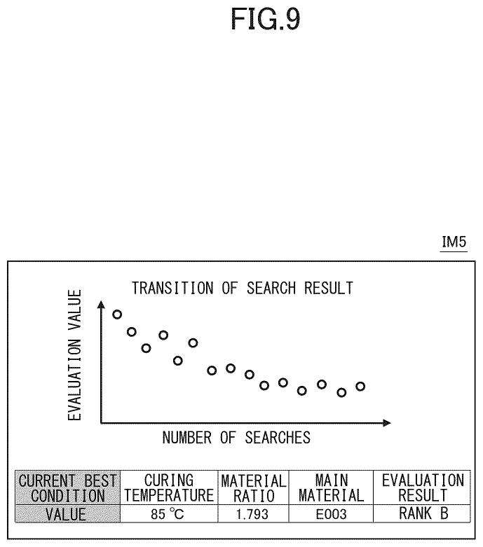

In addition, the evaluation portion 107 may repeat the search cycle described above a plurality of times, display an image IM5 illustrated in FIG. 9 on the display apparatus 104, and notify the user of the transition of the evaluation value E20 (search result). Then, the evaluation portion 107 may display, in the image, the manufacturing condition in which the evaluation value E20 at that time is the best.

In addition, even in the case where the finishing condition illustrated in FIG. 4A is satisfied, a function to not satisfy the finishing condition in the case where there is still data that needs to be re-evaluated may be added because there is a possibility that a better manufacturing condition will be obtained.

In addition, in the case where the number of evaluation results E2 (evaluation values E20) that need to be corrected has reached a predetermined number, the sample manufacturing apparatus 101 may stop the manufacture of the sample in accordance with a command from the evaluation portion 107, for example, terminate the manufacture of the sample, because in the case where the number of data that need to be evaluated increases too much, a possibility that a sample evaluated low continues to be manufactured increases. In addition, the manufacture and measurement of the sample may be performed sample by sample, or may be performed for a plurality of samples at once.

In addition, in the case of simultaneously improving a plurality of kinds of measurement values, a graph illustrated in FIG. 9 may be individually generated for each measurement value, or something in which how good or bad a plurality of measurement values are is expressed by one indicator, such as hypervolume, may be generated.

As described above, according to the first embodiment, the evaluation value E20 that is the evaluation result E2 can be corrected at the discretion of the user, the estimator is updated in accordance with the result, and thus the next manufacturing condition is obtained. As a result of this, evaluation results (data) of a number required for optimization are obtained, and after evaluation results that need to be corrected among the plurality of evaluation results are corrected to evaluation results of higher precision, search for the next manufacturing condition can be performed with higher precision, and a manufacturing condition matching the search condition is determined in a short period of time even in the case where the measurement result is abstract sensory information like the image IM2. That is, a manufacturing condition in which a sample of good quality can be manufactured is obtained in a short period of time.

### First Modification Example

Although a case where the sensory sensor is a visual sensor and the amount of scratch on the sample is automatically evaluated by using the image IM2 has been described as an example in the first embodiment described above, the configuration is not limited to this. This can be also applied to a case where a sensory sensor measures a smell, a taste, a texture in mouth, or a design property such as a color balance or a shape related to the look of food.

The taste can be measured by using a taste sensor as the measurement apparatus 102 (sensory sensor). Regarding the learning data, measurement items for which the user has conducted a sensory test and measurement results thereof that can be expressed by numerical values such as bitterness, sweetness, acidity, saltiness, and the like may be prepared as the learning data in advance, and the learning portion 106 may perform machine learning on this learning data.

Further, the measurement apparatus 102 may be configured to automatically measure the sample, and the evaluation portion 107 may cause the sample manufacturing apparatus 101 to manufacture the sample, cause the measurement apparatus 102 to measure the sample, and evaluate the rank of the measurement result of the sample by using the trained machine learning model M1.

Then, the evaluation portion 107 adds a label to be re-evaluated to the evaluation value E20 whose difference ΔP in the probability is less than the threshold value. Then, the labeled evaluation value E20 is re-evaluated by the user, thus the estimator is updated, and the next manufacturing condition is obtained.

As a result of this, while securing the number of data required for the optimization, the search for the next manufacturing condition can be performed with high precision after the precision of the measurement result has improved, and thus the manufacturing condition can be determined in a short period of time.

To be noted, although a case where the sensory sensor is a taste sensor has been described as an example, the configuration is not limited to this, and the sensory sensor may be an olfactory sensor or a pressure sensor. In addition, the sensory sensor is not limited to one type, and for example, the sensory sensor may be at least one of a visual sensor, an olfactory sensor, a taste sensor, and a pressure sensor. For example, the olfactory sensor can be used for detecting the smell, and the pressure sensor can be used for detecting texture in mouth.

### Second Embodiment

A second embodiment will be described. In the description below, it is assumed that elements denoted by the same reference signs as in the first embodiment have substantially the same configurations and functions as those described in the first embodiment unless described otherwise, and part different from the first embodiment will be mainly described.

A case where the user corrects the evaluation result has been described in the first embodiment. In the second embodiment, a case where a different measurement apparatus re-measures the sample will be described.

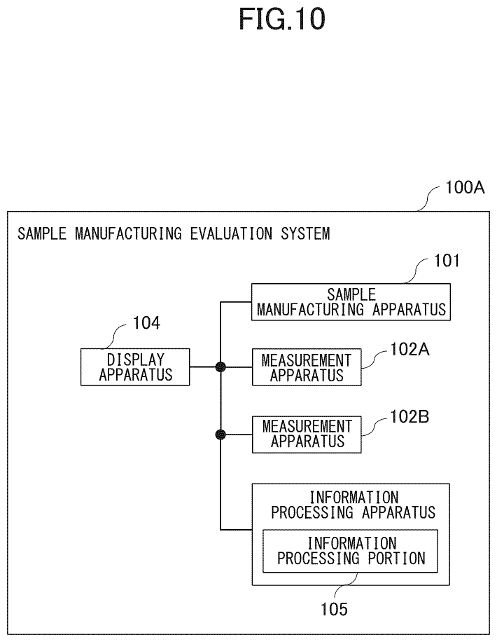

FIG. 10 is a block diagram of a sample manufacturing evaluation system 100A according to the second embodiment. The sample manufacturing evaluation system 100A includes the sample manufacturing apparatus 101, a measurement apparatus 102A, a measurement apparatus 102B, the information processing apparatus 103, and the display apparatus 104. In the second embodiment, the measurement apparatuses 102A and 102B are provided instead of the measurement apparatus 102 of the first embodiment. The measurement apparatuses 102A and 102B are each an apparatus to measure the sample.

The measurement apparatus 102A has a lower measurement precision than the measurement apparatus 102B, but needs a shorter time for measurement than the measurement apparatus 102B. The measurement apparatus 102B has a higher measurement precision than the measurement apparatus 102A, but needs a longer time for measurement than the measurement apparatus 102A. That is, the measurement apparatus 102B can measure the sample with a higher precision than the measurement apparatus 102A. The measurement apparatus 102A is an example of a first measurement apparatus, and the measurement apparatus 102B is an example of a second measurement apparatus.

In the second embodiment, the information processing portion 105 determines the manufacturing condition of the sample by replacing a measurement result of the measurement apparatus 102A of a lower measurement precision by a measurement result obtained by re-measurement by the measurement apparatus 102B of a higher measurement precision.

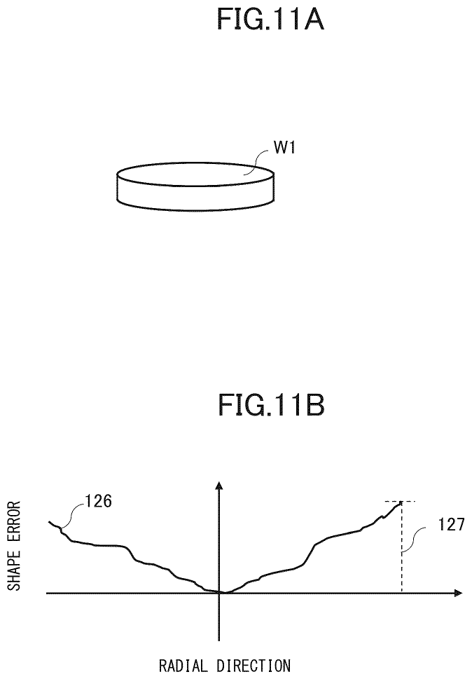

FIG. 11A is a schematic perspective view of a sample W1 according to the second embodiment. The sample W1 is, for example, an optical element. The measurement apparatuses 102A and 102B are each configured to measure the shape of the surface of the sample W1 manufactured by the sample manufacturing apparatus 101. That is, the information processing portion 105 is configured to be capable of obtaining the measured shape of the surface of the sample W1 from the measurement apparatuses 102A and 102B.

FIG. 11B is an explanatory diagram of a shape error 126 according to the second embodiment. The shape error 126 is a difference between the designed shape of the surface of the sample W1 and the measured shape of the surface of the sample W1. The shape error 126 serves as an evaluation result, and a peak-to-valley (PV) value 127 of the shape error 126 serves as an evaluation value. The PV value 127 is the maximum value of the shape error 126. The product is better when the PV value 127 serving as the evaluation value is smaller.

In the second embodiment, the information processing portion 105 uses the measurement apparatus 102A with a higher priority to measure the sample, evaluates the sample W1 on the basis of the measurement result of the measurement apparatus 102A, and obtains the evaluation result of the sample W1. Then, in the case where the shape error 126 serving as an evaluation result does not satisfy a predetermined condition, the information processing portion 105 causes the measurement apparatus 102B to measure the sample W1, evaluates the sample W1 on the basis of the measurement result of the measurement apparatus 102B, and updates the evaluation result of the sample W1.

In the second embodiment, the predetermined condition is that the PV value 127 is equal to or larger than a threshold value. That is, in the case where the PV value 127 obtained from the measurement result of the measurement apparatus 102A is smaller than the threshold value, the information processing portion 105 causes the measurement apparatus 102B to measure the sample W1, evaluates the sample W1 on the basis of the measurement result of the measurement apparatus 102B, and updates the evaluation result of the sample W1. To be noted, the predetermined condition is not limited to the example described above.

As described above, in the case where the measurement result is equal to or larger than the threshold value, the information processing portion 105 does not perform the re-measurement because the possibility that the sample is a good product is low, and in the case where the measurement result is smaller than the threshold value, the information processing portion 105 performs the re-measurement because the possibility that the sample is a good product is high.

In addition, the information processing portion 105 is configured to obtain an estimator by using the PV value 127 serving as an evaluation value, and update the manufacturing condition by using the estimator. The estimator is configured in substantially the same manner as in the first embodiment.

In the case where the evaluation value is updated, that is, in the case where the re-measurement is performed, the information processing portion 105 obtains the estimator by using the updated evaluation value. That is, the information processing portion 105 updates the estimator by using the PV value 127 replaced by the re-measured value, and determines the next manufacturing condition.

In the second embodiment, a lot of samples W1 are measured in a short time by using the measurement apparatus 102A. As a result of this, the number of times the sample W1 is measured by using the measurement apparatus 102B that requires a long measurement time can be reduced, and thus the time to determine the manufacturing condition of the sample W1 can be shortened. A manufacturing condition in which a sample of a good quality can be obtained in a short period of time.

### Third Embodiment

A third embodiment will be described. In the description below, it is assumed that elements denoted by the same reference signs as in the first embodiment have substantially the same configurations and functions as those described in the first embodiment unless described otherwise, and part different from the first embodiment will be mainly described.

A case where the user corrects the evaluation result has been described in the first embodiment, and a case where another measurement apparatus re-measures the sample has been described in the second embodiment. In the third embodiment, a case where an evaluation value exceeding a threshold value for a target value is kept, samples are manufactured again in only manufacturing conditions corresponding to evaluation values within a range defined by the threshold value, and the evaluation values are updated on the basis of the result of re-measurement will be described.

The sample manufacturing evaluation system according to the third embodiment is substantially the same as that of the first embodiment. In the third embodiment, the information processing portion 105 performs re-manufacture and re-measurement of the sample, and determines the manufacturing condition of the sample satisfying the predetermined condition on the basis of the measurement result.

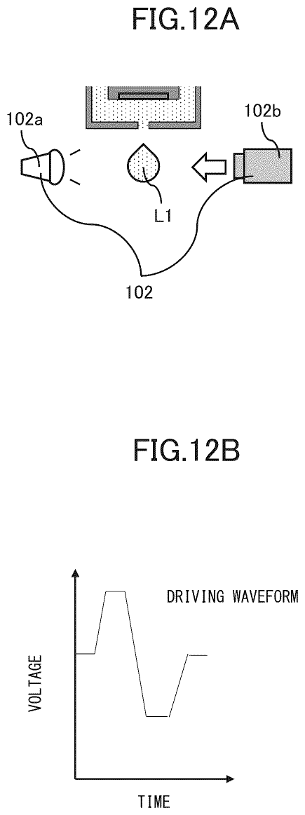

FIG. 12A is a schematic side view of a sample L1 according to the third embodiment and a measurement apparatus 102 that measures the sample L1. The sample L1 is, for example, a droplet ejected from an ejection head of an ink jet apparatus. The measurement apparatus 102 is used for measuring the ejection amount and ejection speed of the manufactured sample L1, and includes, for example, an imaging system including a light source 102a and a high-speed camera 102b. The measurement apparatus 102 is configured to image the sample L1 that is in the air after being ejected from the ejection head of the ink jet apparatus. That is, the information processing portion 105 controls the light source 102a to irradiate the sample L1 in the air with light, controls the camera 102b to image the sample L1 in the air by the camera 102b, and thus obtains an image from the camera 102b. The information processing portion 105 is configured to perform image processing on the image obtained from the camera 102b, and calculate the ejection amount and the ejection speed of the sample L1. To be noted, as another example of a measurement method for the ejection amount, the information processing portion 105 may detect the shape of the droplet by using the light source 102a and the camera 102b to image the sample L1 that is a droplet having hit an evaluation substrate, detect the shape of the droplet from the image obtained from the camera 102b, and calculate the ejection amount from the shape of the droplet. In the present embodiment, a case where the control of the measurement apparatus 102, image acquisition, and image processing are performed by the information processing portion 105 has been described as an example, but the configuration is not limited to this. For example, the measurement apparatus 102 may be an independent measurement apparatus including an information processing portion for the measurement apparatus, and data of the ejection amount and the ejection speed measured by the measurement apparatus may be transferred to the information processing portion 105.

FIG. 12B is an explanatory diagram illustrating an example of a manufacturing condition for manufacturing the sample L1 according to the third embodiment. The manufacturing condition for the sample L1 is a driving waveform for driving a pressure-generating mechanism of the ejection head. In the graph illustrated in FIG. 12B, the horizontal axis represents the time, and the vertical axis represents the voltage applied to the pressure-generating mechanism. The driving of the pressure-generating mechanism is controlled by the driving waveform illustrated in FIG. 12B.

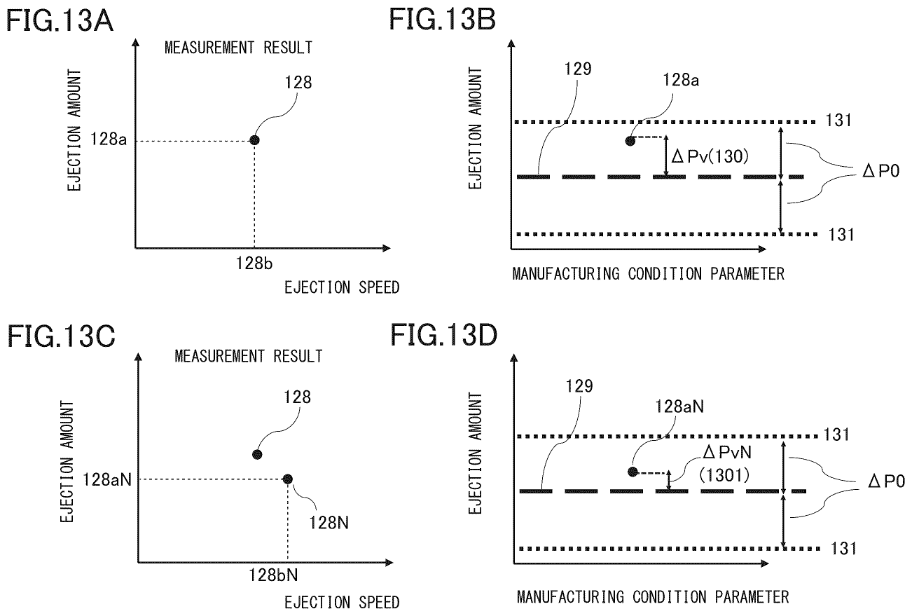

FIG. 13A is a graph illustrating an example of a measurement result 128 of the sample L1 according to the third embodiment. The horizontal axis of the graph illustrated in FIG. 13A represents the ejection speed of the sample L1, and the vertical axis represents the ejection amount of the sample L1. By measuring the sample L1 by using the measurement apparatus 102, an ejection amount 128a and an ejection speed 128b of the sample L1 are obtained as the measurement result 128. The ejection amount 128a and the ejection speed 128b are each an example of a measurement value. The measurement result 128 is an example of a first measurement result.

FIG. 13B is a graph illustrating a difference between the ejection amount 128a and a target ejection amount 129 of the sample L1 according to the third embodiment. The horizontal axis of the graph illustrated in FIG. 13B represents the manufacturing condition parameter, and the vertical axis represents the ejection amount. The target ejection amount 129 is an example of a set target value. Threshold values 131 are set to define a range of ΔP0 from the target ejection amount 129. The threshold values 131 are threshold values based on the target ejection amount 129. A value 130 of |ΔPv| that is the difference between the ejection amount 128a and the target ejection amount 129 serves as the evaluation value. The value 130 of |ΔPv| serving as the evaluation value is an example of a first evaluation value. The value 130 of |ΔPv| is better when smaller.

FIG. 13C is a graph illustrating an example of a measurement result 128N of the sample L1 according to the third embodiment. The horizontal axis of the graph illustrated in FIG. 13C represents the ejection speed of the sample L1, and the vertical axis represents the ejection amount of the sample L1. The measurement result 128N illustrated in FIG. 13C is a measurement result updated by re-manufacture and re-evaluation performed in accordance with the re-presented manufacturing condition. By measuring the re-manufactured sample L1 by using the measurement apparatus 102, an ejection amount 128aN and an ejection speed 128bN are obtained as a re-evaluated measurement result 128N. The ejection amount 128aN and the ejection speed 128bN are each an example of a measurement result. The measurement result 128N is an example of a second measurement result.

FIG. 13D is a graph illustrating the difference between the ejection amount 128aN and the target ejection amount 129 of the sample L1 according to the third embodiment. The horizontal axis of the graph illustrated in FIG. 13D represents the manufacturing condition parameter, and the vertical axis represents the ejection amount. A value 1301 of |ΔPvN| that is the difference between the ejection amount 128aN and the target ejection amount 129 is set as the evaluation value. The value 1301 of |ΔPvN| serving as the evaluation value is an example of a second evaluation result. The value 1301 of |ΔPvN| is better when smaller.

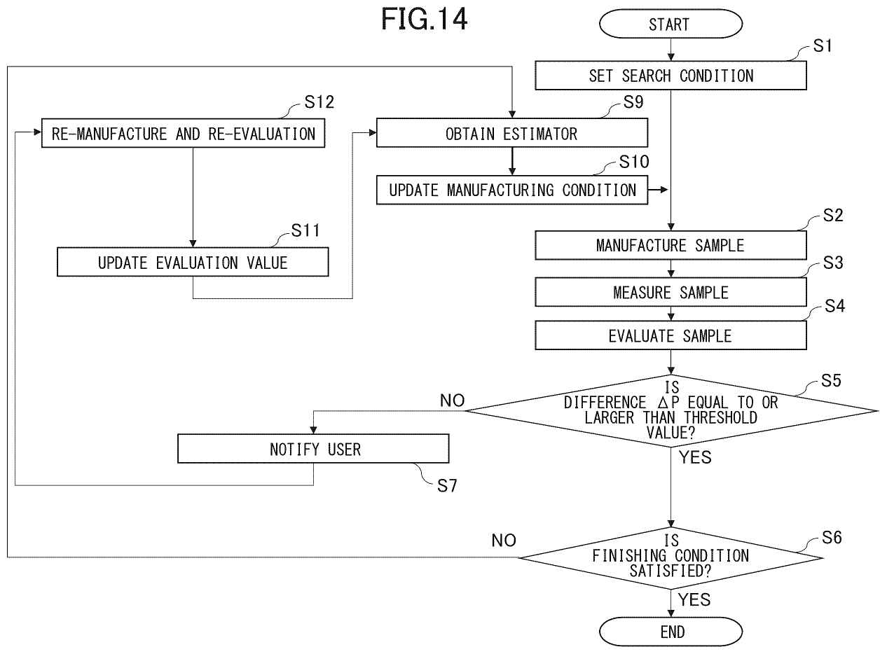

FIG. 14 is a flowchart of a sample manufacturing evaluation method of the sample manufacturing evaluation system 100 according to the third embodiment, that is, a flowchart of a control method for the sample manufacturing evaluation system 100.

In step S1, the information processing portion 105 presents the manufacturing condition to the sample manufacturing apparatus 101. In step S2, the sample manufacturing apparatus 101 manufactures the sample. In step S3, the information processing portion 105 causes the measurement apparatus 102 to measure the sample L1. Then, in step S4, the information processing portion 105 evaluates the sample L1 in accordance with the measurement result 128 obtained by the measurement apparatus 102, and thus obtains the value 130 of |ΔPv| serving as an evaluation value of the sample L1.

In step S5, in the case where the value 130 of |ΔPv| serving as the evaluation value of the sample L1 does not satisfy a predetermined condition, that is, in the case where the result of step S5 is YES, the information processing portion 105 proceeds to step S6.

In step S6, the information processing portion 105 determines whether or not a finishing condition is satisfied. In the case where the evaluation value does not satisfy the predetermined condition, that is, in the case where step S6 is No, the information processing portion 105 proceed sot step S9.

In step S9, the information processing portion 105 obtains the estimator from the obtained evaluation value, and determines the next manufacturing condition on the basis of the estimator. Then, in step S10, the information processing portion 105 updates the manufacturing condition.

In the case where the predetermined condition is satisfied in step S5, that is, in the case where step S5 is NO, in step S7, the information processing portion 105 presents the manufacturing condition of the sample L1 to the user again. Then, in step S12, the information processing portion 105 performs the manufacture and evaluation again, and thus obtains the measurement result 128N.

Next, in step S11, the information processing portion 105 performs averaging processing of averaging the measurement result 128 and the measurement result 128N, and performs re-evaluation on the basis of the result of the averaging processing, that is, the average value. Then, the information processing portion 105 updates the evaluation value of the sample L1 to the value 1301 of |ΔPvN|, updates the estimator in step S9 on the basis of the evaluation value updated in step S11, and determines the next manufacturing condition in step S10.

The evaluation value in the third embodiment is the value 1301 of |ΔPvN| that is the difference between the ejection amount 128aN of the measurement result 128N and the target ejection amount 129, but the configuration is not limited to this. For example, in the case where measurement results of a plurality of items such as the ejection amount 128aN and the ejection speed 128bN are obtained, the evaluation value may be a value determined on the basis of a formula constituted by the combination of the plurality of items.

The predetermined condition in the third embodiment is a condition that the value 130 of |ΔPv| falls within a range |ΔP0| defined by the threshold values 131. The threshold values 131 can be, for example, values of ±10% from the target ejection amount 129. To be noted, the predetermined condition is not limited to the example described above. In addition, the predetermined condition does not have to be applied from the initial stage of the search, and may be applied after searches of a number designated by the user.

In the third embodiment, the information processing portion 105 can perform the manufacture and evaluation a designated number of times in the presented manufacturing condition, and obtain measurement values representing measurement results of a designated number of searches. One or more may be designated as the designated number, and the designated number may be designated and changed by the user.

The information processing portion 105 performs manufacture and evaluation of the sample a designated number of times in the presented manufacturing condition, and performs averaging processing of averaging the plurality of measurement results 128 by a predetermined method. As an example of the predetermined method, there are methods such as a method of calculating the average value of all of the plurality of measurement values as described above, and a method of excluding measurement values out of a predetermined range from the plurality of measurement values as outliers and calculating the average value of the remaining values of the plurality of measurement values excluding the outliers. The outliers can be, for example, out of a range of the average ±3×standard deviation. Alternatively, there is a method of performing the averaging processing by using a combination of measurement values whose standard deviation is smaller than a predetermined value of standard deviation among the plurality of measurement values. The method of the averaging processing may be designated and changed by the user.

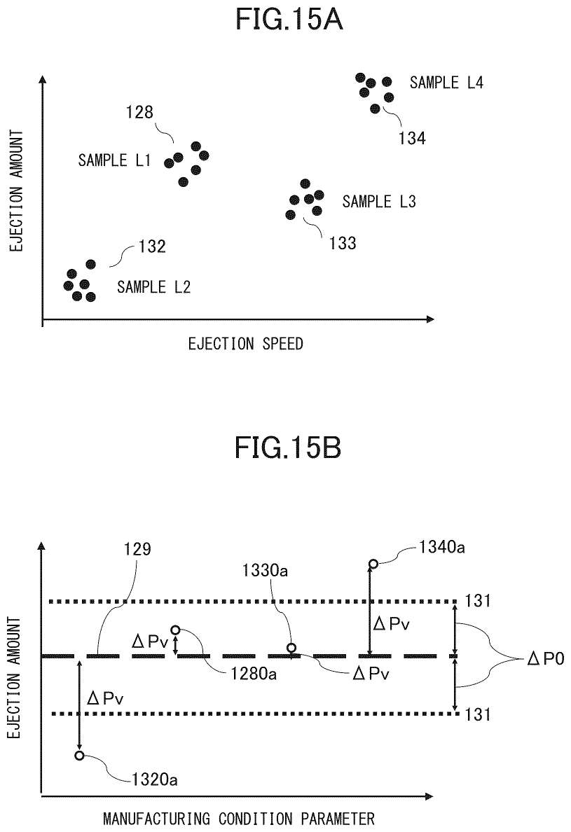

FIG. 15A is a graph illustrating an example of measurement results of a plurality of samples L1 to L4 according to the third embodiment. In FIG. 15A, the horizontal axis represents the ejection speed, and the vertical axis represents the ejection amount. An example in which the manufacture and evaluation are performed six times and the search is performed four times will be described.

Measurement results 128, 132, 133, and 134 are respectively sets of measurement results of the samples L1 to L4. The measurement results of six times of each of the samples L1 to L4 vary. As causes for the variations, fluctuation derived from the measurement apparatus, fluctuation of the apparatus control system of the sample manufacturing apparatus, change in the material physical property caused by change over time, fluctuation of the surrounding environmental condition, and the like can be mentioned. The causes of the variations are not included in the manufacturing condition parameter.

FIG. 15B is a graph illustrating the difference between the target ejection amount 129 and the average ejection amount of each of the plurality of samples L1 to l4 according to the third embodiment. FIG. 15B illustrates the relationship between the average value of the measurement results of each of the samples L1 to L4, the target ejection amount 129 serving as a target value, the difference ΔPv between the target ejection amount 129 and the average value of the measurement results of each of the samples L1 to L4, and the threshold values 131. Average ejection amounts 1280a, 1320a, 1330a, and 1340a respectively represent the average values of the ejection amounts of the measurement results of the samples L1 to L4.

As illustrated in FIG. 15B, for the samples L2 and L4, the value of |ΔPv| serving as an evaluation value is beyond the threshold values 131, and for the samples L1 and L3, the value of |ΔPv| serving as an evaluation value is within the range ΔP0 of the threshold values 131.

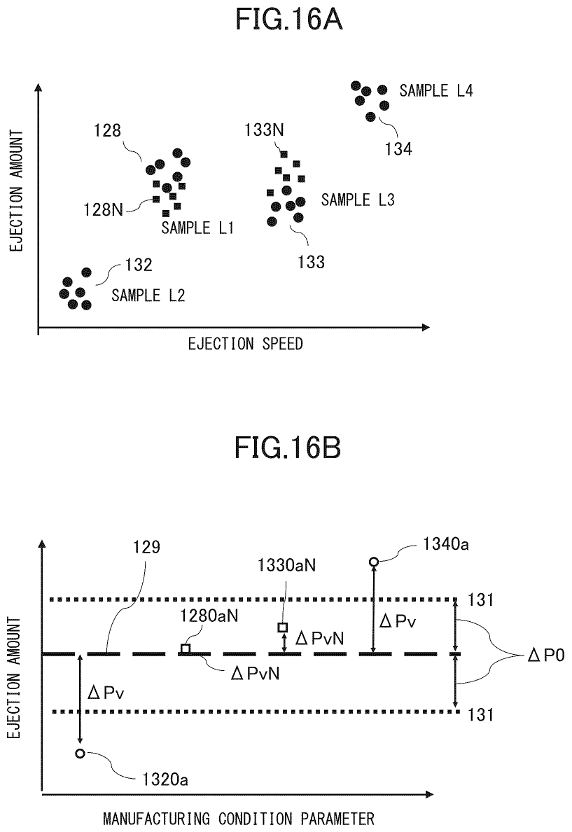

The information processing portion 105 re-presents the manufacturing condition for the samples L1 and L3 for which the value of |ΔPv| satisfies the predetermined condition at the end of the fourth search, and performs the manufacture and evaluation of the sample a designated number of times again. As a result of this, as illustrated in FIG. 16A, measurement results 128N and 133N serving as second measurement results are obtained.

FIG. 16A is a graph illustrating an example of measurement results of the plurality of samples L1 to L4 according to the third embodiment. In FIG. 16A, the horizontal axis represents the ejection speed, and the vertical axis represents the ejection amount. FIG. 16A illustrates an example in which the measurement results of the samples L1 and L3 are updated by re-manufacturing and re-evaluating the samples L1 and L3 in the re-presented manufacturing conditions.

FIG. 16B is a graph illustrating the difference between the target ejection amount 129 and the average ejection amount of each of the plurality of samples L1 to L4 according to the third embodiment. FIG. 16B illustrates the relationship between the average value of the measurement results of each of the samples L1 to L4, the target ejection amount 129 serving as a target value, the difference ΔPv (ΔPvN) between the target ejection amount 129 and the average value of the measurement results of each of the samples L1 to L4, and the threshold values 131. Average ejection amounts 1280aN, 1320a, 1330aN, and 1340a respectively represent the average values of the ejection amounts of the measurement results of the samples L1 to L4.

In FIG. 16B, the average ejection amount 1280a is updated to the average ejection amount 1280aN, the average ejection amount 1330a is updated to the average ejection amount 1330aN, and thus the value of |ΔPv| serving as the evaluation value thereof is updated to the value of |ΔPvN|.

The average value of all of the plurality of previous measurement results 128 and the updated measurement results 128N of the sample L1 is the ejection amount 1280aN. In addition, the average value of all of the plurality of previous measurement results 133 and the updated measurement results 133N of the sample L3 is the ejection amount 1330aN.

The information processing portion 105 calculates the value of |ΔPvN| serving as an evaluation value for each of the samples L1 and L3. The information processing portion 105 updates the estimator in accordance with the value of |ΔPv| serving as the evaluation value of each of the samples L1 and L4 and the value of |ΔPvN| serving as the evaluation value of each of the samples L2 and L3, and determines the next manufacturing condition.

To be noted, although a case where the information processing portion 105 performs the averaging processing on the measurement values has been described in the third embodiment, the configuration is not limited to this. For example, the information processing portion 105 may perform the averaging processing on the evaluation values (first evaluation results and second evaluation results) obtained from the measurement values. The user can appropriately designate whether to average the measurement values or average the evaluation values.

That is, the information processing portion 105 of the information processing apparatus 103 performs averaging processing of averaging a plurality of first measurement results in the case where one or more first measurement results are the plurality of first measurement results, averaging processing of averaging one or more first measurement results and one or more second measurement results, averaging processing of averaging a plurality of first evaluation results in the case where one or more first evaluation results are the plurality of first measurement results, or averaging processing of averaging one or more first evaluation results and one or more second evaluation results.

In addition, although an example in which the information processing portion 105 instructs re-manufacture at once for all the manufacturing conditions of the sample satisfying the predetermined condition has been described in the third embodiment, the configuration is not limited to this. For example, the flowchart may be made such that the information processing portion 105 instructs the re-manufacture each time the predetermined condition is satisfied, and this can be arbitrarily selected by the user.

Here, in the case where the manufacture and measurement of the sample vary, there is a possibility that the manufacturing condition to be presented next has an error if the estimator is generated by using an evaluation value obtained from a measurement result of a sample manufactured by one trial production and thus the update processing is performed. As a result, there is a possibility that the number of searches increases and the number of trials until the target ejection amount serving as a target value is reached becomes enormous. In the case where the ejection amount is obviously deviated from the target ejection amount and the predetermined condition is not satisfied, even if there are variations in the measurement results, since the ejection amount is greatly deviated from the target ejection amount, the contribution of the evaluation value to the estimator is small, and it is inefficient to repeat the manufacture and measurement of the sample in a region where the evaluation value is large. Meanwhile, in the case where the predetermined condition is satisfied, the variations cannot be ignored because the ejection amount is close to the target ejection amount.

In contrast, in the third embodiment, the measurement results 128N are added only in the case where the predetermined condition is satisfied, thus the precision of the measurement results can be improved, and the manufacturing condition in which a sample of a good quality is manufactured can be presented in a short period of time.

Further, in the third embodiment, in the case where there are variations in the measurement results due to the fluctuation of each apparatus of the sample manufacturing apparatus 101 or the measurement apparatus 102, the information processing portion 105 repeats the manufacture and evaluation of the sample a plurality of times, and performs evaluation by using the averaged value. As a result of the averaging processing, the precision of the measurement value and the evaluation value is improved, the number of searches can be reduced, and the manufacturing condition of the sample can be determined in a short period of time. To be noted, the third embodiment can be also applied to tuning of a manufacturing process in accordance with the manufacturing environment of the manufacturing apparatus.

As described above, according to the present disclosure, a manufacturing condition in which a sample of a good quality is manufactured is obtained in a short period of time.

The present disclosure is not limited to the embodiments described above, and the embodiments can be modified in many ways within the technical concept of the present disclosure. For example, among the plurality of embodiments and modification examples described above, at least two may be combined. In addition, the effects described in the present embodiment are merely enumeration of the most preferable effects that can be obtained from the embodiments of the present disclosure, and the effects of the embodiments of the present disclosure are not limited to those described in the present embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. No. 2024-187791, filed Oct. 24, 2024, and Japanese Patent Application No. 2025-158188, filed Sep. 24, 2025, which are hereby incorporated by reference herein in their entirety.

What is claimed is:

1. A sample manufacturing evaluation system comprising:
a sample manufacturing apparatus configured to manufacture a sample on a basis of a manufacturing condition;
a measurement apparatus configured to measure the sample; and
an information processing apparatus configured to evaluate the sample on a basis of a measurement result of the measurement apparatus and obtain an evaluation result of the sample,
wherein in a case where the evaluation result does not satisfy a predetermined condition, the information processing apparatus issues a notification that the evaluation result needs to be corrected.

2. The sample manufacturing evaluation system according to claim 1, wherein the sample manufacturing apparatus manufactures the sample on a basis of the manufacturing condition that has been updated.

3. The sample manufacturing evaluation system according to claim 1, wherein each time the manufacturing condition is updated, the sample manufacturing apparatus manufactures the sample on a basis of the updated manufacturing condition.

4. The sample manufacturing evaluation system according to claim 3, wherein in a case where a number of the evaluation results that need to be corrected has reached a predetermined number, the sample manufacturing apparatus stops manufacture of the sample.

5. The sample manufacturing evaluation system according to claim 1,
wherein the evaluation result includes an evaluation value,
wherein the information processing apparatus is configured to obtain an estimator by using the evaluation value, and update the manufacturing condition by using the estimator, and
wherein in a case where correction of the evaluation value is received, the information processing apparatus obtains the estimator by using the corrected evaluation value.

6. The sample manufacturing evaluation system according to claim 5, wherein the evaluation result includes a plurality of rank values, and one of the plurality of rank values is the evaluation value.

7. The sample manufacturing evaluation system according to claim 6,
wherein the evaluation result includes a plurality of probabilities respectively corresponding to the plurality of rank values, and
wherein the information processing apparatus sets, as the evaluation value, a rank value corresponding to a first probability that is highest one of the plurality of probabilities.

8. The sample manufacturing evaluation system according to claim 7, wherein the predetermined condition is a condition that a difference between the first probability and a second probability that is second highest one of the plurality of probabilities is equal to or larger than a threshold value.

9. The sample manufacturing evaluation system according to claim 1, wherein the information processing apparatus obtains the evaluation result of the measurement result by using a trained machine learning model.

10. The sample manufacturing evaluation system according to claim 1,
wherein the measurement apparatus is a sensory sensor, and
wherein the information processing apparatus obtains, as the measurement result, sensory information of the sample from the sensory sensor.

11. The sample manufacturing evaluation system according to claim 10, wherein the sensory sensor is at least one of a visual sensor, an olfactory sensor, a taste sensor, or a pressure sensor.

12. The sample manufacturing evaluation system according to claim 1, further comprising:
a display apparatus,
wherein in the case where the evaluation result of the sample does not satisfy the predetermined condition, the information processing apparatus issues the notification by displaying, on the display apparatus, an image indicating that the evaluation result needs to be corrected.

13. The sample manufacturing evaluation system according to claim 12, wherein the information processing apparatus displays, on the display apparatus, a user interface image for receiving correction of the evaluation result from a user.

14. A sample manufacturing evaluation system comprising:
a sample manufacturing apparatus configured to manufacture a sample on a basis of a manufacturing condition;
a first measurement apparatus configured to measure the sample;
a second measurement apparatus configured to measure the sample with a higher precision than the first measurement apparatus; and
an information processing apparatus configured to evaluate the sample on a basis of a measurement result of the first measurement apparatus and obtain an evaluation result of the sample,
wherein in a case where the evaluation result does not satisfy a predetermined condition, the information processing apparatus causes the second measurement apparatus to measure the sample, evaluates the sample on a basis of a measurement result of the second measurement apparatus, and updates the evaluation result of the sample.

15. The sample manufacturing evaluation system according to claim 14,
wherein the evaluation result includes an evaluation value,
wherein the information processing apparatus is configured to obtain an estimator by using the evaluation value, and update the manufacturing condition by using the estimator, and
wherein in a case where the evaluation value is updated, the information processing apparatus obtains the estimator by using the updated evaluation value.

16. The sample manufacturing evaluation system according to claim 15,
wherein the first measurement apparatus and the second measurement apparatus are each an apparatus configured to measure a shape of a surface of the sample,
wherein the measurement result is the measured shape of the surface, and
wherein the evaluation result is a difference between the measured shape and a designed shape.

17. The sample manufacturing evaluation system according to claim 16, wherein the predetermined condition is a condition that a maximum value of the difference is equal to or larger than a threshold value.

18. The sample manufacturing evaluation system according to claim 15, wherein the sample manufacturing apparatus manufactures the sample on a basis of the manufacturing condition that has been updated.

19. A sample manufacturing evaluation system comprising:
a sample manufacturing apparatus configured to manufacture a sample on a basis of a manufacturing condition;
a measurement apparatus configured to measure the sample; and
an information processing apparatus configured to evaluate the sample on a basis of a measurement result of the measurement apparatus and obtain an evaluation result of the sample,
wherein the information processing apparatus is configured to:
in a case where at least one first evaluation result obtained from at least one first measurement result of the sample manufactured in accordance with the manufacturing condition satisfies a predetermined condition, cause the sample manufacturing apparatus to re-manufacture the sample;
obtain at least one second measurement result from the measurement apparatus by causing the measurement apparatus to measure the re-manufactured sample;
obtain at least one second evaluation result on a basis of the at least one second measurement result; and
update the manufacturing condition on a basis of the at least one second evaluation result.

20. The sample manufacturing evaluation system according to claim 19, wherein the information processing apparatus performs averaging processing to average a plurality of first measurement results in a case where the at least one first measurement result is the plurality of first measurement results, averaging processing to average the at least one first measurement result and the at least one second measurement result, averaging processing to average a plurality of first evaluation results in a case where the at least one first evaluation result is the plurality of first evaluation results, or averaging processing to average the at least one first evaluation result and the at least one second evaluation result.

21. A control method for a sample manufacturing evaluation system including a sample manufacturing apparatus, a measurement apparatus, and an information processing apparatus, the control method comprising:
causing the sample manufacturing apparatus to manufacture a sample on a basis of a manufacturing condition;
causing the measurement apparatus to measure the sample;
causing the information processing apparatus to evaluate the sample on a basis of a measurement result of the measurement apparatus and obtain an evaluation result of the sample; and
in a case where the evaluation result does not satisfy a predetermined condition, causing the information processing apparatus to issue a notification that the evaluation result needs to be corrected.

22. A control method for a sample manufacturing evaluation system including a sample manufacturing apparatus, a first measurement apparatus, a second measurement apparatus having a higher measurement precision than the first measurement apparatus, and an information processing apparatus, the control method comprising:
causing the sample manufacturing apparatus to manufacture a sample on a basis of a manufacturing condition;
causing the first measurement apparatus to measure the sample;
causing the information processing apparatus to evaluate the sample on a basis of a measurement result of the first measurement apparatus and obtain an evaluation result of the sample;
in a case where the evaluation result does not satisfy a predetermined condition, causing the second measurement apparatus to measure the sample; and
causing the information processing apparatus to evaluate the sample on a basis of a measurement result of the second measurement apparatus and update the evaluation result of the sample.

23. A control method for a sample manufacturing evaluation system including a sample manufacturing apparatus, a measurement apparatus, and an information processing apparatus, the control method comprising:
causing the sample manufacturing apparatus to manufacture a sample on a basis of a manufacturing condition;
causing the measurement apparatus to measure the sample to obtain a first measurement result;
causing the information processing apparatus to obtain a first evaluation result on a basis of the first measurement result;
in a case where the first evaluation result satisfies a predetermined condition, causing the sample manufacturing apparatus to re-manufacture a sample;
causing the measurement apparatus to measure the re-manufactured sample to obtain a second measurement result;
causing the information processing apparatus to obtain a second evaluation result on a basis of the second measurement result; and
causing the information processing apparatus to update the manufacturing condition on a basis of the second evaluation result.

24. A non-transitory computer-readable recording medium storing a program for causing a computer to execute the control method according to claim 21.
